(19) United States
(12) Patent Application Publication
(10) Pub. No.: US 2010/0253505 A1
(43) Pub. Date: Oct. 7, 2010

(54) PHYSIOLOGICAL HOMECARE SYSTEM

(76) Inventor: Chang-An Chou, Taipei (TW)

Correspondence Address: Chang-An Chou, 3F, No. 100, Sec. 3. Mingsheng E. Rd., Taipei, 105, TW

(21) Appl. No.: 12/682,252

(22) PCT Filed: Oct. 17, 2008
(86) PCT No.: PCT/CN2008/001754

§ 371 Date: Apr. 9, 2010

(30) Foreign Application Priority Data
Oct. 18, 2007 (CN) 200710181329.2

(51) Int. Cl. G08B 1/08

(52) U.S. Cl. 340/539.12

(57) ABSTRACT

A handheld physiological homecare system including a sensing device and an extension sensing device is provided. The sensing device includes a processor, a signal processing circuitry with input interface, a memory for storing physiological signals and related information, a battery for providing power, a status display unit, for showing physiological information, and a communication interface. The extension sensing device includes at least a sensor/electrode, and a housing having a dock structure and a holding portion. Therefore, after the dock structure of the extension sensing device is mechanically engaged with the sensing device for forming one handheld combined device and electrically connecting the sensor/electrode to the signal processing circuitry, by holding the holding portion, the combined device can be used to acquire physiological signals from user's body, and after biosignal acquisition, the communication interface can be used to output user's physiological information for further analysis.

### FIELD OF THE INVENTION

The present invention is related to a physiological homecare system, and more particularly to a physiological homecare system which can reduce the burden of the user, increase operation convenience and satisfy different measuring purposes.

### BACKGROUND OF THE INVENTION

Nowadays, physiological diagnostics becomes more and more popular since people seek for higher quality of life, so that various home used physiological diagnostic systems have been developed. One of the major purposes of the home used physiological diagnostic system is to provide user the convenience by eliminating the traveling time between home and hospital.

In the market, one common type of home used physiological diagnostic systems is the all-in one system which completes all procedures, such as data acquisition, processing, analysis and display, on one machine.

A common one is, for example, portable EKG detector, such as, HCG-801 (a portable electrocardiometer produced by Omron, and SCS-H10/H20 (an electrocardiogram recording device manufactured by TOSHIBA). Through this kind of all-in-one physiological diagnostic device, as long as the measuring demand rises, user can easily see the physiological signals and the analysis result without complicated wiring connection and/or signal transmission. However, this kind of device is not suitable for long time usage, such as 24-hour measurement, since the volume thereof is difficult to be reduced owing to the all-in-one property.

Another example is as disclosed in U.S. Pat. No. 6,368,287, which provides a wearable sleep apnea screening system. In this system, an irreversible indicator is employed for displaying the screening result, and depending on this, the user can decide the necessity for visiting a doctor. This is a simple, convenient and effective system. But, since the indicator is irreversible, it becomes a one-time-use system and has to be abandoned no matter the screening is successful or not. That is, even an error is made by placing at an incorrect position or falling off as screening is undergoing, the used system still has to be thrown away. Thereby, the cost is significantly increased.

Besides, since the all-in-one physiological diagnostic device is limited in preformed one-device structure, it is difficult to measure other kinds of physiological signals through the same structure. Therefore, as appearing different demands, the most possible way the user will do is to buy another physiological diagnostic device. It means, although it is convenient to use an all-in-one device at home, there still have many physiological purposes are ignored.

Consequently, the object of the present invention is to provide a physiological diagnostic system more suitable for home use which simultaneously owns the advantages of two above-described systems.

Another object of the present invention is to provide a physiological homecare system capable of satisfying multiple physiological measuring purposes.

### SUMMARY OF THE INVENTION

Generally, physiological diagnostic device used at home is characteristic of convenient operation procedure, but behind the convenience, it always means some tradeoffs are made, such as, just like described above, volume minification and function integrity. This actually is an issue that almost all kinds of physiological diagnostic devices may go through as long as the home use purpose is implemented thereon. Therefore, how to balance two sides becomes important.

The present invention is intended to propose an architecture of physiological device for balancing the two sides which not only provides operation convenience, but also offers function integrity.

Therefore, in one aspect of the present invention, a handheld physiological homecare system is provided. The system includes a sensing device and an extension sensing device. The sensing device includes a processor, a signal processing circuitry with input interface, a memory for storing physiological signals and related information, a battery for providing power, a status display unit, for showing physiological information, and a communication interface. The extension sensing device includes at least a sensor/electrode, and a housing having a dock structure and a holding portion. Moreover, the dock structure of the extension sensing device is mechanically engaged with the sensing device for forming one handheld combined device and electrically connecting the sensor/electrode to the signal processing circuitry, so that by holding the holding portion, the combined device can be used to acquire physiological signals from user's body, and after biosignal acquisition, the communication interface can be used to output user's physiological information for further analysis.

In accordance with the architecture described above, it can be seen that the extension device provides an external change for the sensing device, especially in shape alteration of whole structure and position rearrangement of sensor/electrode, which makes the system more suitable for handheld operation, so as to solve the problem that the conventional all-in-one device only can provide single type of operation mode without adaptability.

Preferably, the handheld combined device can be used to acquire EKG signals through contacting the electrodes, which are located on the surface of the extension sensing device, with user's body surface, or can be implemented to detect oxygen saturation by employing an oximeter. Moreover, particularly, in addition to connect to the sensor/electrode on the extension device, the sensing device also can be connected to other sensor(s)/electrode(s), for example, but not limited, EKG electrodes (for performing the EKG signal detection in wearing mode), EEG electrodes, EOG electrodes, EMG electrodes, blood pressure detector, airflow sensor, respiratory effort sensor, body temperature sensor, snore sensor, oxygen saturation detector, body position sensor, and limb movement sensor, so as to perform physiological diagnostics alone. Then, if there is the need to attach the sensing device to user's body, a carrier can be provided for fixing the sensing device and also the sensor/electrode.

Besides, if the number of the extension sensing device is implemented to be multiple, the system becomes to a one-to-more system, so that the sensing device can be selected to perform different physiological signal acquisitions only by changing the extension sensing device. This provides a multi-purpose system particularly suitable for home use since family members might have different requirements, and the simple mechanical engaging operation also provides an easy way to combine the sensing device and the extension sensing device together without complex assembling procedure.

In another aspect of the present invention, the present invention provides a physiological homecare system including a handheld sensing device and an extension sensing device. The handheld sensing device includes a housing with a holding portion, a processor, at least a sensor/electrode, a signal processing circuitry with input interface, a memory for storing physiological signals and related information, a battery for providing power, a status display unit for showing physiological information, and a communication interface. The extension sensing device includes at least a sensor/electrode, and a housing with a dock structure. Therefore, by holding the holding portion, the handheld sensing device can be used to acquire physiological signals from user's body, and after the dock structure of the extension sensing device is mechanically engaged with the sensing device to form one combined device and electrically connect the sensor/electrode of the extension device to the signal processing circuitry, the combined device can be used for acquiring other physiological signals, and after biosignal acquisition, user's physiological information is outputted via the communication interface for further analysis.

Preferably, the sensing device is implemented to detect EKG or oxygen saturation signals, and the combined device is used to detect blood pressure or EKG signal. Furthermore, as the combined device is used to detect blood pressure, the sensing device may further include an air pumping portion controlled by the processor for producing pressure.

In still another aspect of the present invention, a wearable physiological homecare system is provided which includes a sensing device, a carrier and an extension device. The sensing device includes at least a sensor/electrode, a signal processing circuitry with input interface, a processor for processing and analyzing the physiological signals so as to produce an analysis result, a memory for storing physiological signals and related information, a battery for providing power, and a communication interface. The carrier is used for attaching the sensing device to user's body during biosignal acquisition. The extension device includes a processor unit, a housing with a dock structure, a status display unit, and a first and a second communication ports. Furthermore, after biosignal acquisition, the sensing device is detached from the carrier for mechanically engaging with the dock structure of the extension device and electrically connecting the communication interface to the first communication interface, so that via the communication interfaces, the analysis result can be transmitted from the sensing device to the extension device for displaying, and further, via the second communication interface, user's physiological information can be outputted for further analysis.

According to the description above, for reducing the burden on the user and also for providing more convenient operation, the extension device including the function and structure which might be omitted during long-time biosignal acquisition is divided from the sensing device, and after measurement, through the engagement therebetween, the separated function and structure can be recombined with the sensing device. Here, since the extension device is used to not only show the analysis result but also output the user's physiological information, the extension device actually plays the role of adapter in this system, so that the user can easily realize the analysis result through the status display unit on the extension device, and as the demand for more detailed information rises, the extension device can further be connected to an external device, such as, personal computer, notebook, and PDA, for obtaining more complete analysis which may involve in more complicated calculation. Thus, through this architecture, the problem that the conventional all-in-one device is not suitable for long time usage can be solved.

Furthermore, the physiological signals stored in the memory may have a property of time series, so that the system according to the present invention can provide a more detailed analysis, such as, trend analysis, level indication, and/or value calculation.

Advantageously, the sensor/electrode can be airflow sensor, EKG electrodes, blood pressure detector, and/or oximeter.

### BRIEF DESCRIPTION OF THE DRAWINGS

A more detailed understanding of the invention may be had from the following description of preferred embodiments, given by way of example, and to be understood in conjunction with the accompanying drawings, wherein:

FIG. 1 is a schematic view showing the sensing device in a preferred embodiment according to the present invention;

FIG. 2 is a schematic view showing the relationship between the sensing device and the extension device in a preferred embodiment of the present invention;

FIGS. 3A˜3B are schematic views showing different exemplary implementations of the extension device according to the present invention;

FIG. 4 is a schematic view showing the relationship of the sensing device and the extension sensing device in another preferred embodiment according to the present invention;

FIGS. 5A˜5C are schematic views showing different exemplary implementations of the extension sensing device according to the present invention;

FIG. 6 is a schematic view showing the relationship between the sensing device and the extension sensing device in another preferred embodiment according to the present invention; and

FIG. 7 is a schematic view showing the exemplary implementation of the extension sensing device according to the present invention.

### DETAILED DESCRIPTION OF THE PREFERRED EMBODIMENTS

For achieving the variation of physiological diagnostic device at home, the present invention provides a physiological homecare system, which includes a major sensing device and an extension device. The sensing device is used to acquire physiological signals through sensor and/or electrodes, no matter the sensor/electrode is directly/indirectly connected thereto or mounted thereon. And, if there is a need to place the sensing device on user's body during long-time signal acquisition, a carrier also can be employed to attach the sensing device to the body surface. As to the extension device, it is implemented to electrically connect to the sensing device so as to extend the function of the sensing device and/or to provide additional function thereto.

According to the present invention, it can be divided into two parts, one is the extension device is used to provide additional function for the sensing device and the other is the extension device is employed to extend the function of the sensing device.

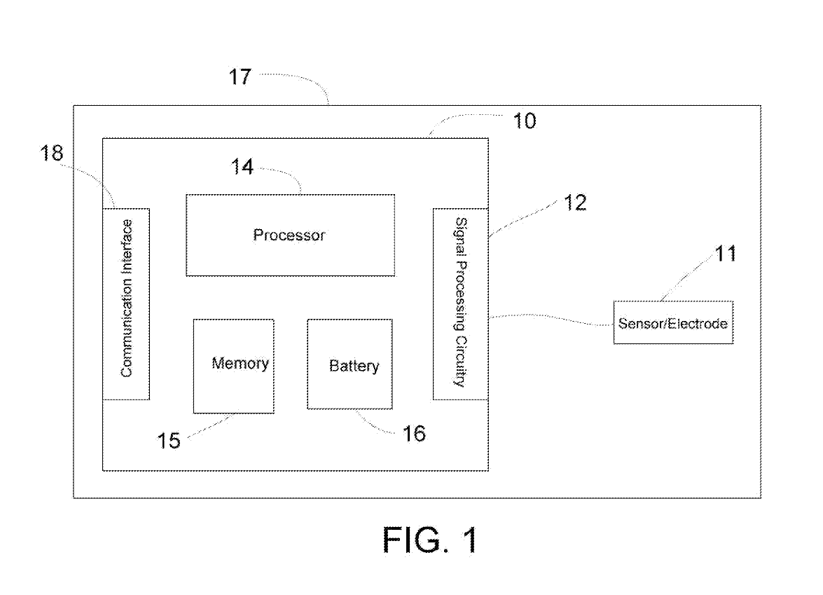

In the first aspect of the present invention, the situation that the extension device is used to provide additional function is described. Please refer to FIG. 1, which is a schematic view showing the sensing device in a preferred embodiment according to the present invention. The sensing device 10 includes a signal processing circuitry 12 with input interface (not shown) for receiving physiological signals, which are acquired by at least a sensor/electrode 11 from user's body, a processor 14 for controlling, a memory 15 for storing physiological signals and related information, a battery 16 for providing power and a communication interface 18 for communicating with the extension device.

Here, the sensor/electrode 11 can have different choices, no matter in quantity or category. That is, it can be implemented to be multiple electrodes (sensors) (for acquiring identical or different kinds of physiological signals), or to be electrodes plus sensor(s), but there is no limitation. For example, if it needs to detect EKG signals, then EKG electrodes are employed, if it needs to detect EEG signals, then EEG electrodes are used, if it needs to know blood oxygen saturation, an oximeter should be used, or if multiple physiological signal detections are desired, it should use multiple kinds of electrodes and/or sensors at the same time. Besides, an acceleration sensor also can be used to detect body movement, such as falling, PLMS (Periodic Leg Movement Syndrome), or RLS (Restless Legs Syndrome), and in this special situation, the acceleration sensor should be located in the sensing device. Of course, there also can have multiple sensing devices mounted on one user's body at the same time without restriction.

Moreover, the physiological homecare system of the present invention can further includes a carrier 17 for attaching the sensing device to user's body, for example, when the sensing device is used to perform the biosignal acquisition for a longer time duration, it might need to attach the sensing device to user's body for saving labors. Besides, if applicable, the carrier also can be performed to carry the sensor/electrode with the sensing device, for better stability. Preferably, the carrier 17 is made of flexible material, such as a belt, or more advantageously, a flexible material capable of carrying circuits, such as FPCB, or a flexible material with adhesive, such as tape, but there is no limitation. Also, the carrier can be implemented to be reusable, or replaceable.

When physiological signals are acquired by the sensor/electrode, they are stored in the memory 15, and then, the physiological signals are processed and analyzed by the processor 14 through a preloaded program, so that an analysis result can be obtained.

As biosignal acquisition finished, the sensing device 10 is detached from the carrier 17 (if exists), so that it can be engaged with the extension device.

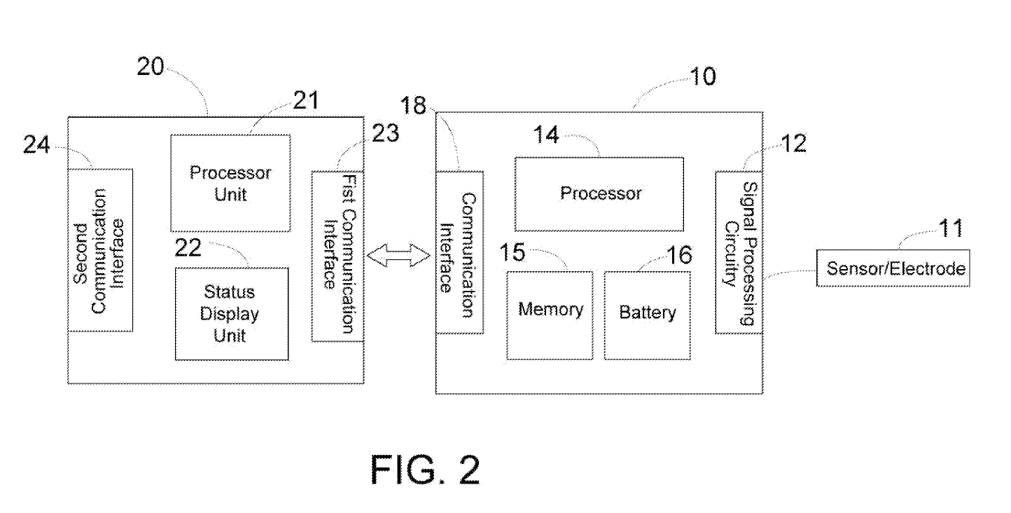

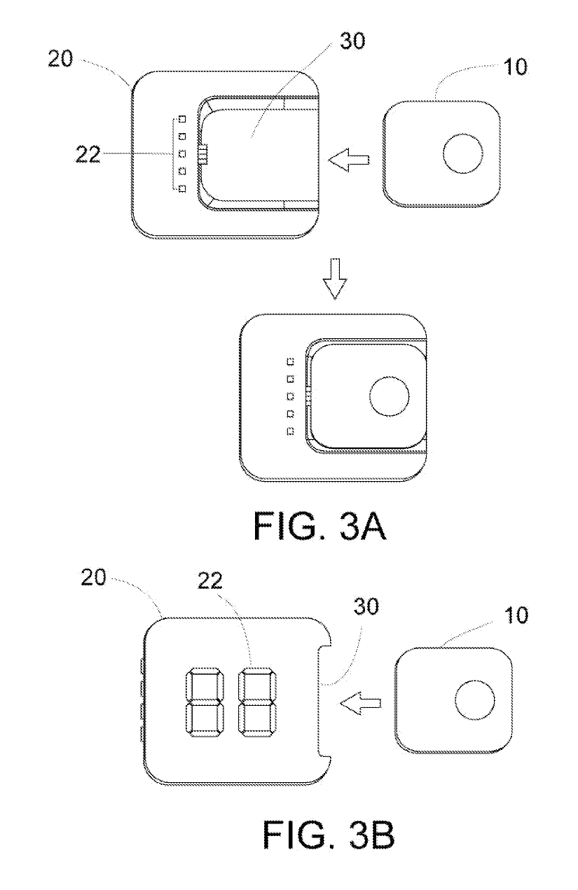

Continuously, please refer to FIG. 2, which is a schematic view showing the relationship between the sensing device and the extension device in a preferred embodiment of the present invention, and FIGS. 3A˜3B, which are schematic views showing different exemplary implementations of the extension device according to the present invention.

The extension device 20 includes a housing with a dock structure 30, a processor unit 21, a status display unit 22, and a first and a second communication interfaces 23 and 24, wherein the dock structure 30 is used to mechanically engage with the sensing device 10, and at the same time, a communication link between the communication interfaces 18, 23 is formed, so that the analysis result can be transmitted from the sensing device 10 to the extension device 20, and then, through the status display unit 22 provided by the extension device 20, the analysis result can be shown for the user.

Here, since the physiological signals are accessed from the memory 15 after a period of time, such as, after several hours or whole night, the physiological signals will possess the property of time series and thus is suitable for period analysis. Therefore, compared with the device which only shows detected values in real time, the present invention can provide a more meaningful analysis result, such as, trend analysis, level indication, and/or value calculation.

Therefore, in this embodiment, the first additional function provided by the extension device is display. As described above, since the all-in-one device is disadvantageous of larger volume and unsuitable for mounting on user for long period of time, the present invention is implemented to separate the display part from the sensing device, so that as the sensing device is mounted on the user, both the volume and weight can be reduced. Then, if the user needs to see the result, he/she only needs to simply engage the sensing device to the dock structure for completing the communication link and transmitting the result to the extension device for displaying, so that even the status display unit is separated from the sensing device, the user still can easily and immediately read the result. And, according to the shown result, the user can instantly decided if there any error has made in this measurement, such as, the placement of sensor/electrode, or if there needs another measurement.

For example, if the sensing device is implemented to be an airflow sensor for apnea screening, then it will be better to locate the device around the face for avoiding from using long connecting wiring since the sensing process should be executed all night and the long connecting wiring might interrupt the sleep so as to further influence the analysis result. Therefore, for providing a more comfortable using condition, the present invention reduces the weight and volume of the conventional sensing device on the body, especially the face, by the divided extension device. And, after biosignal acquisition, the analysis result still can be shown by the extension device as long as the engagement is completed. In addition, more advantageously, if the result shows abnormal or if another diagnostic demand rises, because the whole system of the present invention is reusable, the user can directly execute the measurement once again without paying extra cost. That is, the extension device also provides the capability of reuse.

Furthermore, through the second communication interface 24, the extension device 20 can further be connected to an external device, such as a personal computer, a notebook, or a PDA, so that the physiological information stored in the memory 15 can be outputted for further analysis, for example, for executing more complicated calculation, or for comparing with existed data. Therefore, in addition to the displaying function and reuse capability, the extension device also plays the role of adaptor for connecting the sensing device to the computer for obtaining more complete and complicated analysis, and as the computer is connected to network, a remote service is also available for the user.

Preferably, the status display unit 22 can be implemented as seven segment display, LED (as shown in FIGS. 3A˜3B), or LCD, but not limited. And, in a preferred embodiment, the input interface on the signal processing circuitry and the communication interface can be implemented to locate in the same connecting port, so as to avoid incorrect insertion, reduce device volume and also provide electric isolation during measurement. Furthermore, the connection from the extension device to the computer provides the user the possibility to set the sensing device, e.g., operation schedule and parameters, which means the communication is bidirectional.

Then, following up with the second aspect of the present invention, in which the extension device used to extend the function of the sensing device is described.

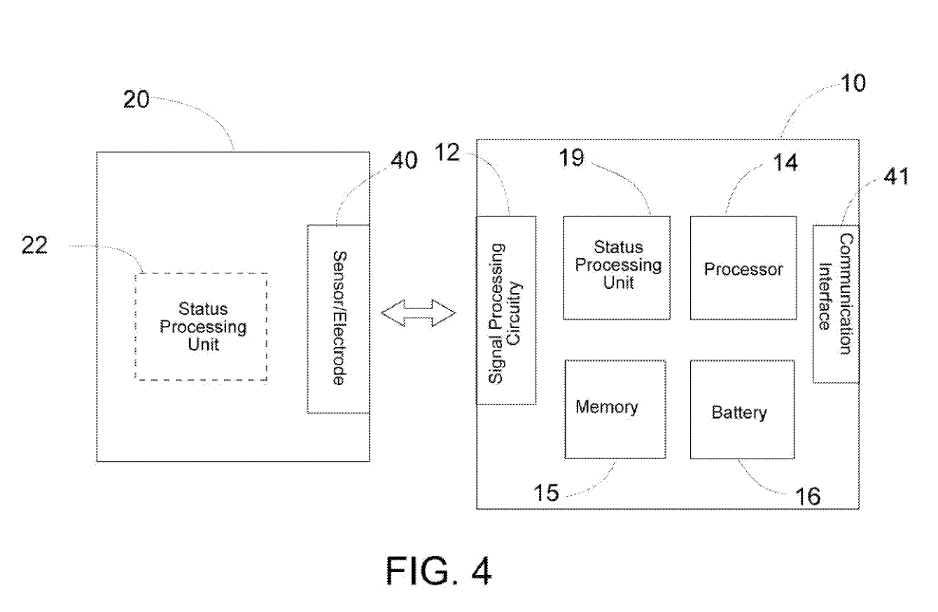

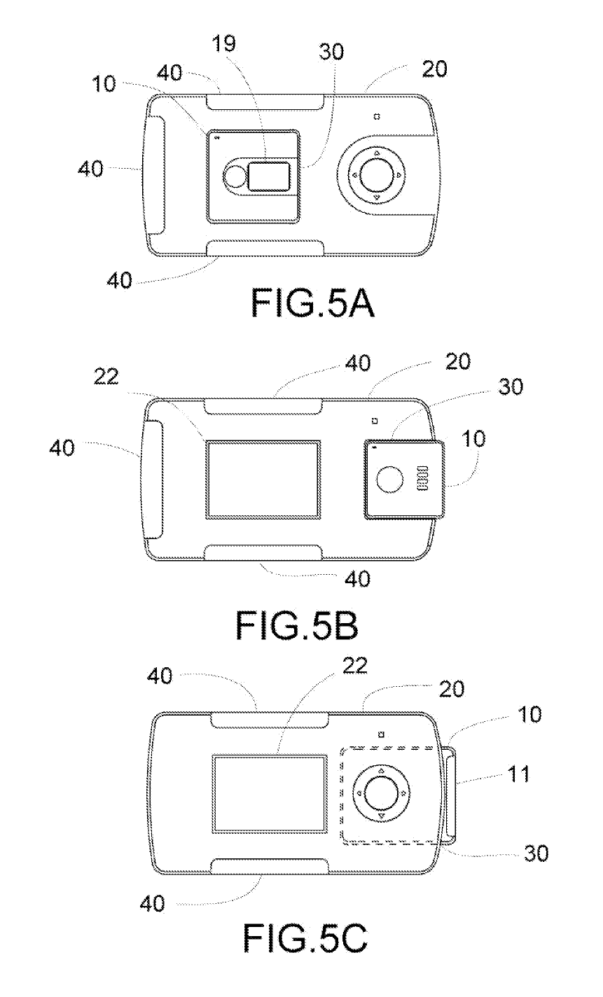

In one preferred embodiment, different from the embodiment described above, the extension device 20 is implemented to extend the sensing function of the sensing device 10, as shown in FIG. 4, which is a schematic view showing the relationship of the sensing device and the extension sensing device in another preferred embodiment according to the present invention, and FIGS. 5A˜5C, which are schematic views showing different exemplary implementations of the extension sensing device according to the present invention.

For providing the additional sensing function, the extension device 20 is implemented to include at least a sensor/electrode 40 for acquiring physiological signals, and the mechanical engagement between the extension device 20 and the sensing device 10 through the dock structure 30 is implemented to form one combined device in shape, as shown in FIGS. 5A˜5C. More importantly, after the engagement, not only two devices are mechanically combined together, the sensor/electrode 40 of the extension device 20 also will be connected to the signal processing circuitry 12 of the sensing device 10, that is, the combined device becomes a new detector different from the sensing device 10 itself. And further, through a holding portion (not indicated since the position thereof might be altered in accordance with different implementations) provided by the housing of the extension sensing device 20, the combined device can be held by the user to perform biosignal acquisition. Here, the physiological signals are acquired by the sensor/electrode 40 on the extension device 20 and are processed and analyzed by the processor 14 in the sensing device 10, so that the whole process is executed by the cooperation between the sensing device 10 and the extension device 20.

Particularly, in this embodiment, in addition to provide the sensing capability, the engagement between the extension device 20 and the sensing device 10 also provides physical variation for the sensing device 10 which makes it more suitable for handheld operation.

When the sensing device 10 itself is formed to have a smaller volume for conforming to the wearing and long-time usage purposes (with the carrier), the user might feel inconvenient as employing the sensing device to perform a short time handheld operation. Therefore, the extension sensing device 20 according to the present invention can simultaneously provide the functions of volume extension and sensor/electrode rearrangement, so as to more fit to user's handheld operation. For example, the sensing device can originally be a wearable EKG detector with small volume and light weight suitable for long-time operation, such as 24-hrs monitoring, and through engaging with the extension device, the sensing device gets additional volume and better electrode arrangement (on the surface of housing) for handheld operation which makes the operation process easier and smoother.

Therefore, through this architecture, only one system can simultaneously achieve two purposes, long-time wearing and short-time handheld operations, which should be performed by two different devices in the prior art, and importantly, the operation comfort is not sacrificed.

In addition to rearrange the position of sensor/electrode, particularly, the extension device also can change the number of sensor/electrode and/or exchange the category of sensor/electrode for providing user sensing variety in accordance with different demands. For example, an EKG sensing device can get an extension of electrode quantity through engaging with the extension device, such as, from a 2 lead EKG detector to a 12-lead EKG detector. Or, the sensing device can originally connect to EKG electrodes for EKG signal acquisition, and then engage with the extension device for changing the sensing type to blood pressure detection, so that both kinds of commonest biosignal acquisitions performed at home are combined in the inventive system. Here, for detecting blood pressure, the sensing unit should be provided to further include an air pumping module (not shown) controlled by the processor, so as to produce pressure during measurement.

As to the engagement between the extension device and the sensing device, the execution thereof depends on individual situations. For example, as shown in FIGS. 5A˜5C, the extension device is used to alter the shape of the sensing device from an attaching mode to a handheld mode, so that the sensing device can be embedded, inserted or parked in the extension device. Alternatively, if the extension device is only used to change the sensing type of the sensing device, the engagement also can be implemented in a simpler way, for example, the extension device simply combines/connects with the sensing device without particularly considering the shape. Thus, there is no limitation.

Moreover, the sensing device 10 also includes a communication interface 41 for outputting the physiological information stored in the memory 15 to an external device, such as, personal computer, notebook, or PDA, for executing a further analysis, such as more complete analysis, more complicated and calculation. And, if the computer is capable of connecting to the network, a remote service can be obtained, such as, comparing with existed database. Preferably, the sensing device and/or the extension device can include a status display unit 19, 22 for showing physiological information during and/or after the biosignal acquisition.

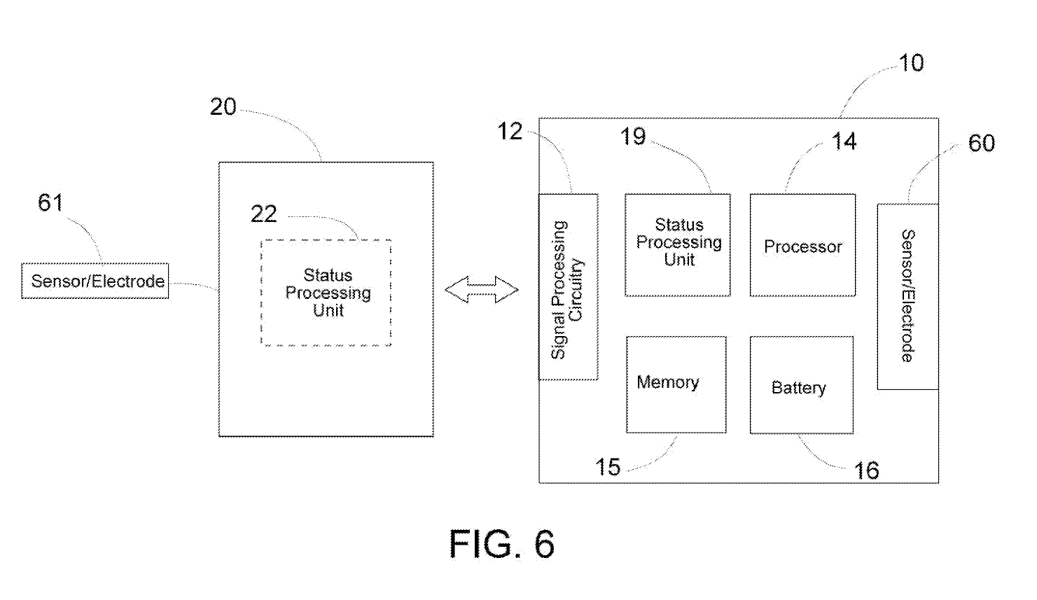

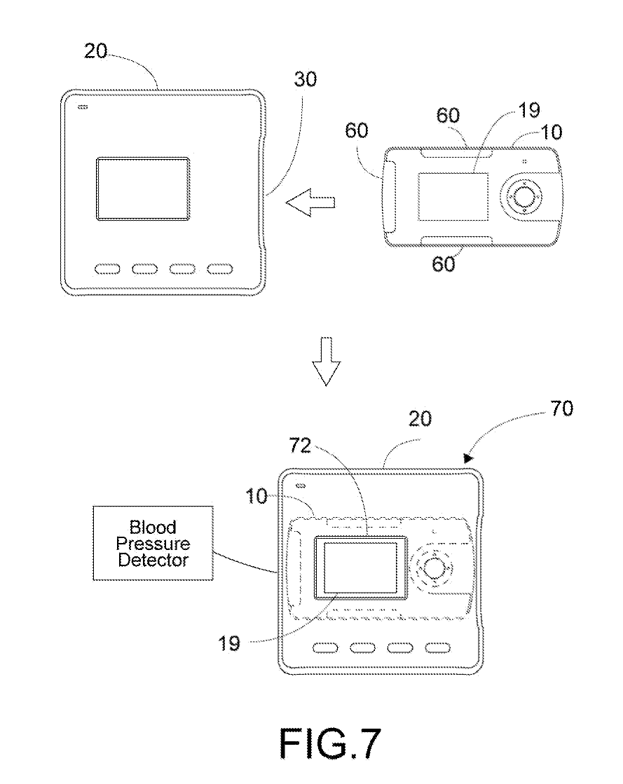

Furthermore, in addition to the examples shown in FIGS. 4˜5 which form the handheld combined device after engagement, the physiological homecare system according to the present invention also can be implemented in another way. Please refer to FIG. 6 which is a schematic view showing the relationship between the sensing device and the extension sensing device in another preferred embodiment according to the present invention, and FIG. 7 which is a schematic view showing the exemplary implementation of the extension sensing device according to the present invention.

In this preferred embodiment, opposite to the embodiment described above, before engagement, the sensing device 10 is implemented to be a handheld device, so that at least a sensor/electrode 60 is already connected thereto. Therefore, when the sensing device 10 is used alone, the user can perform the biosignal acquisition through holding the holding portion (not indicated since the position thereof might be altered in accordance with different implementations) of the housing, and the status display unit 19 is used to show user's physiological information during measurement. Then, as the sensing device 10 is mechanically engaged with the dock structure 30 of the extension device 20, the housing of the extension device 20 will cover the sensor/electrode 60 of the sensing device 10, which means the sensor/electrode 61 of the extension device 20 will replace the sensor/electrode 60 of the sensing device 10. Here, for providing the sensor/electrode 61 the capability of biosignal acquisition, the sensor/electrode 61 also will be connected to the signal processing circuitry 12 of the sensing device 10, so that after the engagement, one combined device also will be formed and the sensor/electrode 61 will replace the sensor/electrode 60 to acquire other physiological signals. Alternatively, in another preferred embodiment, it also can be that after engagement, the sensor/electrode 60 is only partially or is not covered by the sensor/electrode 61, so that the sensors/electrodes 60, 61 can work together in the combined device.

In the example of FIG. 7, the combined device 70 of sensing device 10 and extension device 20 is implemented to detect blood pressure, and the sensing device 10 is implemented to be a handheld EKG detector with electrodes 60 mounted on the surface, so that after the sensing device 10 is taken out, it can be directly used by the user to detect EKG signals. Therefore, two commonest biosignal acquisitions performed at home are combined in the inventive system. Of course, if the combined device is used to detect blood pressure, the sensing device will further include an air pump module for producing pressure. Here, in a particular way, the example shown in FIG. 7 discloses the situation that after the engagement, the status display unit 19 of the sensing device 10 is still used to show physiological information by means of a transparent window 72 on the extension device 20, which reduces the manufacturing cost. However, it also can be the extension device 20 possesses the status display unit as well, there is no limitation. Alternatively, in another example, the combined device of sensing device and extension device also can be implemented to be an EKG detector through wire connecting to electrodes, and as the sensing device is taken out, the oximeter whose detecting structure is mounted on the housing of the sensing device can be directly used by the user. Consequently, the implementation is not restricted.

This is advantageous that the user can directly use the sensing device 10 without additional assembly after the sensing device 10 is taken out from the extension device 20 since the sensor/electrode 60 has already connected to the sensing device 10.

In addition, in another preferred embodiment of the present invention, the number of the extension sensing device can be implemented to be multiple, and different extension devices respond for different kinds of biosignal acquisition. Therefore, through each engagement with one selected extension device, the sensing device can obtain a new sensing function. This is especially suitable for home usage since different family members may have different requirements, so that through this multi-function system, it becomes easier to satisfy this situation. Here, the sensor/electrode provided by the extension sensing device can include, not limited, airflow sensor, respiratory effort sensor, snore sensor, oxygen saturation detector, body position sensor, limb movement sensor, blood pressure detector, body temperature sensor, EKG electrodes, EEG electrodes, EOG electrodes, and EMG electrodes.

Consequently, through the extension sensing device, the physiological homecare system of the present invention can provide variation of sensing capability, so that single physiological homecare system can satisfy different sensing demands without additional purchases.

Furthermore, the communication between the extension device and the sensing device also can be implemented as wireless. Particularly, during biosignal acquisition by the sensing device alone, in addition to memory storage, the wireless communication therebetween also can provide physiological information to the extension device for displaying, so that the user and/or the care giver can get a real time notice.

Besides, the sensing device also can provide a warning function. For example, a program preloaded in the processor of the sensing device for deciding if the received biosignals conform to a preset threshold or condition, such as, a breath frequency or a heart rate range, can trigger a warning, such as vibration or sound, for informing the user to look for medical assistance, or the sensing device can output a warning signal to the extension device through the wireless communication for notifying the care giver, and even, if the extension device is connected with network (with or without the computer), then the warning signal can be transmit to a remote monitoring center, such as hospital, for asking for emergency rescue.

Further, the sensing device also can output different sensible signals in accordance with different physiological conditions sensed. This is particularly suitable for biofeedback field. For example, the sensing device can use the variation of light, sound and/or vibration to notify the user the change of physiological condition, such as, an expected condition is achieved, so that the user can realize that he/she has to remain the current condition or change to another condition. The physiological signals used in biofeedback field usually are, not limited, EEG signals, EMG signals, temperature, and skin conductance.

In the aforesaid, the present invention provides a novel architecture of physiological homecare system by separating the conventional physiological diagnostic device into two parts, a sensing device and an extension device, wherein the sensing device is employed to acquire physiological signals from user's body and the extension device is used to extend and/or increase function for the sensing device.

In one aspect, owing to the separation, the sensing device can have more suitable volume and weight for long time operation. And, through a mechanical engagement and an electrical connection between the sensing device and the extension device, firstly, the extension device can provide a displaying function for the sensing device, so that the user can immediately realize the analysis result without further employing other device, and if further analysis is needed, the extension device also plays the role of adapter for connecting the sensing device to a computer, so that more detailed, completed and complicated analysis and calculation are also available.

Furthermore, in another aspect, through the engagement, the extension device also can provide an additional sensing function for the sensing device. The extension device(s) can rearrange the position of electrode/sensor, change the number of electrode/sensor and/or exchange the category of electrode/sensor, so that different diagnostic demands can be satisfied in one single system. Besides, the extension sensing device also can provide a new shape for the system, for example, particularly, the extension sensing device and the sensing device can engage together to form a handheld combined device so as to provide a more convenient operation mode as needed.

Therefore, the physiological homecare system of the present invention not only can achieve the purposes of convenient operation and user comfort, but also can provide the benefit of function integrity, so that it provides a great flexibility in operation which makes it more suitable for home use.

The above examples and disclosure are intended to be illustrative and not exhaustive. These examples and description will suggest many variations and alternatives to one of ordinary skill in this art. All these alternatives and variations are intended to be included within the scope of the attached claims. Those familiar with the art may recognize other equivalents to the specific embodiments described herein which equivalents are also intended to be encompassed by the claims attached hereto.

What is claimed is:

1. A handheld physiological homecare system, comprising:
a sensing device, comprising:
a processor;
a signal processing circuitry with input interface;
a memory, for storing physiological signals and related information;
a battery, for providing power;
a status display unit, for showing physiological information; and
a communication interface; and
an extension sensing device, comprising:
at least a sensor/electrode; and
a housing, having a dock structure and a holding portion,
wherein
the dock structure of the extension sensing device is mechanically engaged with the sensing device for forming one handheld combined device and electrically connecting the sensor/electrode to the signal processing circuitry, so that by holding the holding portion, the combined device is used to acquire physiological signals from user's body, and after biosignal acquisition, the communication interface is used to output user's physiological information for further analysis.

2. The system as claimed in claim 1, wherein the combined device is used to detect EKG signals or oxygen saturation signals.

3. The system as claimed in claim 1, wherein the sensing device further includes at least a sensor/electrode connecting to the signal processing circuitry for acquiring physiological signals alone.

4. The system as claimed in claim 3, wherein the sensing device is used to detect EKG signals.

5. The system as claimed in claim 1, wherein the sensing device further includes a blood pressure detector connecting to the signal processing circuitry for providing blood pressure information.

6. The system as claimed in claim 5, wherein the sensing device further includes an air pumping module controlled by the processor for producing pressure as detecting blood pressure.

7. The system as claimed in claim 1, further comprising a carrier for attaching the sensing device to user's body for biosignal acquisition.

8. The system as claimed in claim 1, wherein the electrodes of the extension sensing device are mounted on the surface of the housing.

9. The system as claimed in claim 8, wherein the extension sensing device is implemented to detect EKG signals.

10. The system as claimed in claim 1, wherein the quantity of the extension sensing device is implemented to be plurality.

11. The system as claimed in claim 10, wherein the sensor/electrode of multiple extension sensing devices are used to acquire different kinds of physiological signals.

12. The system as claimed in claim 1, wherein the physiological signals are outputted by the communication interface to a computer for further analysis.

13. The system as claimed in claim 12, wherein the computer is further connected to a network for acquiring a remote service.

14. The system as claimed in claim 1, wherein the communication interface and the input interface are implemented to locate in the same connecting port.

15. A physiological homecare system, comprising:
a handheld sensing device, comprising:
a housing with a holding portion;
a processor;
at least a sensor/electrode;
a signal processing circuitry with input interface;
a memory, for storing physiological signals and related information;
a battery, for providing power;
a status display unit, for showing physiological information; and
a communication interface; and
an extension sensing device, comprising:
at least a sensor/electrode; and
a housing with a dock structure,
wherein
by holding the holding portion, the handheld sensing device is used to acquire physiological signals from user's body;
after the dock structure of the extension sensing device is mechanically engaged with the sensing device to form one combined device and electrically connect the sensor/electrode of the extension device to the signal processing circuitry, the combined device is used for acquiring other physiological signals; and
after biosignal acquisition, user's physiological information is outputted via the communication interface for further analysis.

16. The system as claimed in claim 15, wherein the sensing device is implemented to detect EKG or oxygen saturation signals.

17. The system as claimed in claim 15, wherein the combined device is implemented to detect blood pressure or EKG signal.

18. The system as claimed in claim 17, wherein the sensing device further includes an air pumping portion controlled by the processor for producing pressure as the combined device is used to detect blood pressure.

19. The system as claimed in claim 15, wherein the extension sensing device further includes a status display unit for showing physiological information.

20. A wearable physiological homecare system, comprising:
a sensing device, comprising:
at least a sensor/electrode;
a signal processing circuitry with input interface;
a processor, for processing and analyzing the physiological signals, so as to produce an analysis result;
a memory, for storing physiological signals and related information;
a battery, for providing power; and
a communication interface;
a carrier, for attaching the sensing device to user's body during biosignal acquisition; and
an extension device, comprising:
a processor unit;
a housing with a dock structure;
a status display unit; and
a first and a second communication interfaces,
wherein
after biosignal acquisition, the sensing device is detached from the carrier for mechanically engaging with the dock structure of the extension device and electrically connecting the communication interface to the first communication interface, so that via the communication interfaces, the analysis result is transmitted from the sensing device to the extension device for displaying, and further, via the second communication interface, user's physiological information is outputted for further analysis.

21. The system as claimed in claim 20, wherein the sensor is an airflow sensor.

22. The system as claimed in claim 20, wherein the electrodes are EKG electrodes.

23. The system as claimed in claim 20, wherein the memory is implemented to be removable memory.

24. The system as claimed in claim 20, wherein the input interface and the communication interface of the sensing device are implemented to locate in the same connecting port.

25. The system as claimed in claim 20, wherein the carrier is made of flexible material.

26. The system as claimed in claim 25, wherein the carrier is made of FPCB.

27. The system as claimed in claim 20, wherein the status display unit is implemented to be LED, LCD or seven segment display.

28. The system as claimed in claim 20, wherein the second communication interface is connected to a computer for outputting physiological information from the sensing device engaged with the dock structure to the computer, so as to perform further analysis.

29. The system as claimed in claim 28, wherein the computer is a personal computer, a notebook, or a PDA.

30. The system as claimed in claim 28, wherein the computer is further connected to a network for obtaining a remote service.
